(19) United States
(12) Patent Application Publication
(10) Pub. No.: US 2019/0085819 A1
(43) Pub. Date: Mar. 21, 2019

(54) Multifunctional wind turbine / hydro turbine and their assembly for multiple applications and uses

(71) Applicant: TECHSAFE GLOBAL, Paris (FR)

(72) Inventor: Tuan Nghiem VU, Vitry Sur Seine (FR)

(21) Appl. No.: 16/073,796

(22) PCT Filed: Jan. 16, 2017
(86) PCT No.: PCT/IB2017/050218

§ 371 Date: Nov. 27, 2018

(30) Foreign Application Priority Data
Feb. 10, 2016 (FR) 16/00226

(51) Int. Cl. F03D 3/04; F03D 3/02; F03B 17/06; F03D 9/46; F03D 3/00; F03D 3/06; F03D 80/00; F03D 9/11; B60L 11/18

(52) U.S. Cl. CPC F03D 3/0418; B60L 2230/30; F03B 17/063; F03D 9/46; F03D 3/005; F03D 3/065; F03D 3/061; F03D 80/00; F03D 9/11; B60L 11/1838; F05B 2240/12; F05B 2210/16; F05B 2240/211; F05B 2240/40; F05B 2240/9113; B60L 2200/32; B60L 2230/24; F03D 3/02

(57) ABSTRACT

The present invention concerns a device transforming the energy from fluid flows into mechanical and electrical energy. The sources of primary energy are wind for the wind turbine version, or hydraulic flows such as marine or river currents, waves and tides, etc. for the water or hydro turbine version.

The device consists of a fluid guidance system (1), a rotor comprising at least two regularly arranged blades (2), a protective structure (4), a structuring framework (6), a top box (5) and a bottom box (7).

The device will play the role not only of wind turbine/water turbine but also of noise barriers, wave barriers, safety barriers and wireless electrical charging systems along the transport networks.

This invention is intended for companies or organizations producing electricity and individuals wishing to produce electricity.

Winds, rivers, marine or river currents, waves and tides are well known as the most widespread renewable and sustainable energy sources in the world. Therefore, the development of wind turbines and water turbines is currently booming.

The present invention concerns a device which transforms into mechanical and electrical energy, the energy generated by fluid flows, such as air flows or wind for the wind turbine version, or hydraulic flows such as watercourses, rivers, marine or fluvial currents, waves and tides for the water or hydro turbine version. The water turbines will be immersed in water.

Despite many advantages of vertical axis wind turbines or vertical wind turbines, horizontal axis wind turbines or horizontal wind turbines are currently the most used and known because of their better efficiency. However, horizontal wind turbines also have many disadvantages, such as noise pollution, visual impacts, dangers linked to the risks of falling structures, collisions with flying objects, the needs of space and the needs of the lamellar wind, etc. Horizontal wind turbines require open environments. This reduces land use efficiency in a horizontal axis wind farm. Horizontal wind turbines are not very suitable in cities, confined spaces and in bird migration corridors.

The classical vertical wind turbines of the Savonius and Darrieus type have many strong points, as they are space-saving, silent, can be used almost everywhere for all types of wind, have little environmental impact and the possibility of starting at low wind speed, etc. The major problems that prevent the development of vertical wind turbines mainly concern their low efficiency, their large structural mass and their integrity, because their design is not optimized.

Indeed, the wind has negative effects on the return blade of vertical wind turbines. This significantly reduces their efficiency.

On the other hand, horizontal and vertical wind turbines cannot currently operate when the wind speed is too low or too high for technical and safety reasons.

The device of the present invention allows solving the problems of low efficiency of the current vertical wind turbines/water turbines while reinforcing their safety and reducing their environmental impacts.

This invention improves the efficiency or effectiveness of vertical wind turbines and water turbines by collecting more flow and directing fluxes with negative effects on rotor rotation into fluxes with positive effects on rotor rotation. On the other hand, the present invention allows to extend the operating conditions of wind turbines/water turbines at a lower and higher flow speed or velocity, thus increasing the effective operating period of wind turbines/water turbines.

The present invention allows to lighten the force of the flows on the structure of the wind turbines/water turbines, thus reducing the mass of the structures for the same stability of the installation. It also proposes modes of assembling wind turbines/water turbines to improve their performance and mechanical stability.

The wind turbine version of this invention is designed and optimized to adapt to any environment, where wind can be present, onshore and offshore as well as along highways, roads, railways, in tunnels, on fields, on hills, on buildings, on roofs, on balconies, on terraces or by the riversides, by the sea, in offshore wind farms, etc.

Installed along roads, highways, etc., the wind turbine installations of this invention will provide electricity for lighting and for stations or charging stations for electric vehicles along transport networks. This will be very beneficial in remote and isolated geographical areas from the global electricity GRID and for wireless electricity charging systems along transport networks. This kind of contactless electric charging for running vehicle along transport networks will reduce the amount of energy stored on vehicles, thereby reducing vehicle weight and energy consumption. This will reduce the risk of fire, explosion and electrical hazards associated with energy storage systems on the vehicles.

The water turbine version of this invention may be installed in watercourses, in rivers, in coastal zones, in basin draining and filling zones or in aquatic breeding zones, etc. where water currents and waves may exist.

The water turbines of this invention installed along rivers or watercourses will provide electricity for conventional and wireless electric boat charging stations along watercourses in the future. The water turbines of the present invention will also allow to substitute conventional hydraulic dams in the current hydroelectric plants which currently cause a lot of environmental impacts. Dams disrupt aquatic and terrestrial ecosystems, they prevent the migration of fishes, they cause blockages of alluvium, problems of impoverishment of rivers downstream of rivers leading to diminutions of species, water level, and the fertility of watercourses while promoting the infiltration of salt water in coastal areas downstream. Significant environmental impacts have been noticed around the world. On the other hand, hydraulic dams present risks of dam failure. Giant hydraulic dams can potentially generate significant force on tectonic plates and cause earthquakes in surrounding areas. The rows of water turbines of the present invention installed along the rivers and coastal areas will act as waves barriers and will protect dikes from erosions caused by water currents and waves. So, they will contribute to reduce the risk of dikes and dams' ruptures.

The present invention is illustrated by the 60 drawings presented in the 28 annexed figures as follows:

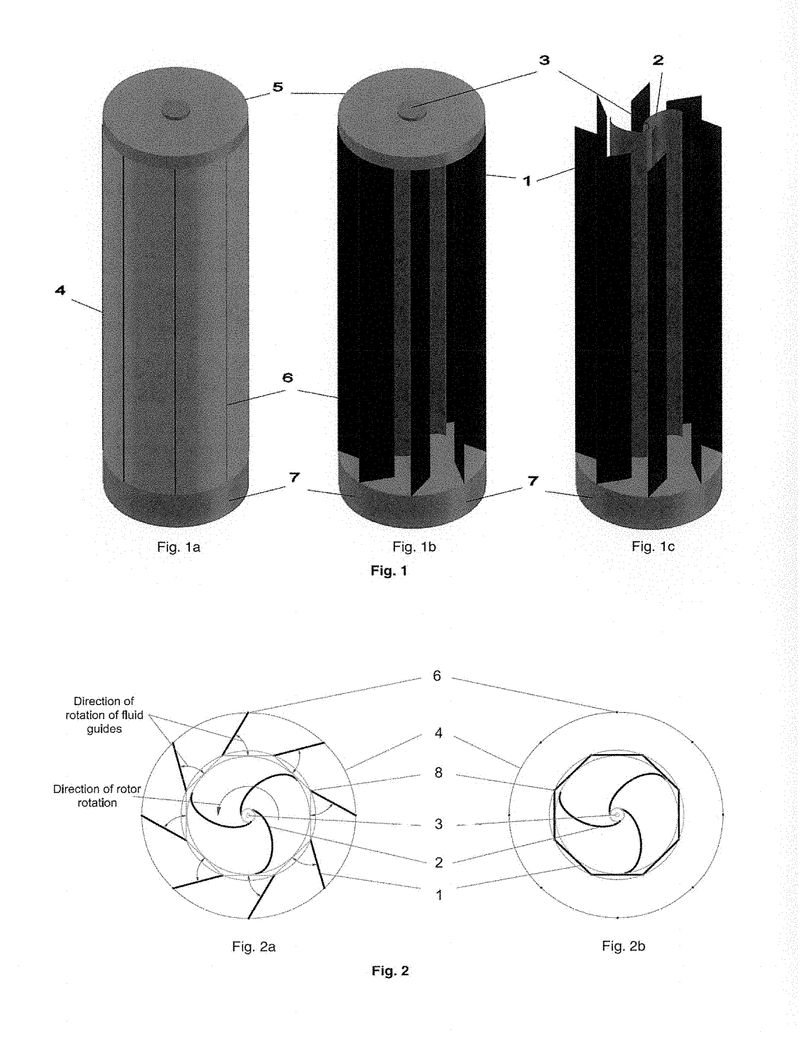

FIG. 1: The FIG. 1 represents a general 3D view of a vertical wind turbine/water turbine: FIG. 1a—General perspective view; FIG. 1b—General view without external protective structure; FIG. 1c—General view without external protective structure and without top box.

Where: 1—Fluid guidance (wind, water flow . . . ); 2—Rotor blades/vanes; 3—Rotor rotation axis; 4—Protective structure; 5—Top box; 6—Structuring framework; 7—Bottom box.

FIG. 2: The FIG. 2 shows a vertical wind turbine/water turbine seen from above in cross-section with blades, flat fluid guidance (wind, water flow . . . ), with rotation indication, in operating position (FIG. 2a) and in safety stop position (FIG. 2b).

Where: 1—Fluid guides (wind, water flow . . . ); 2—Rotor blades; 3—Rotor rotation axis; 4—Protective structure; 6—Structuring framework; 8—Rotation axis of fluid guidance.

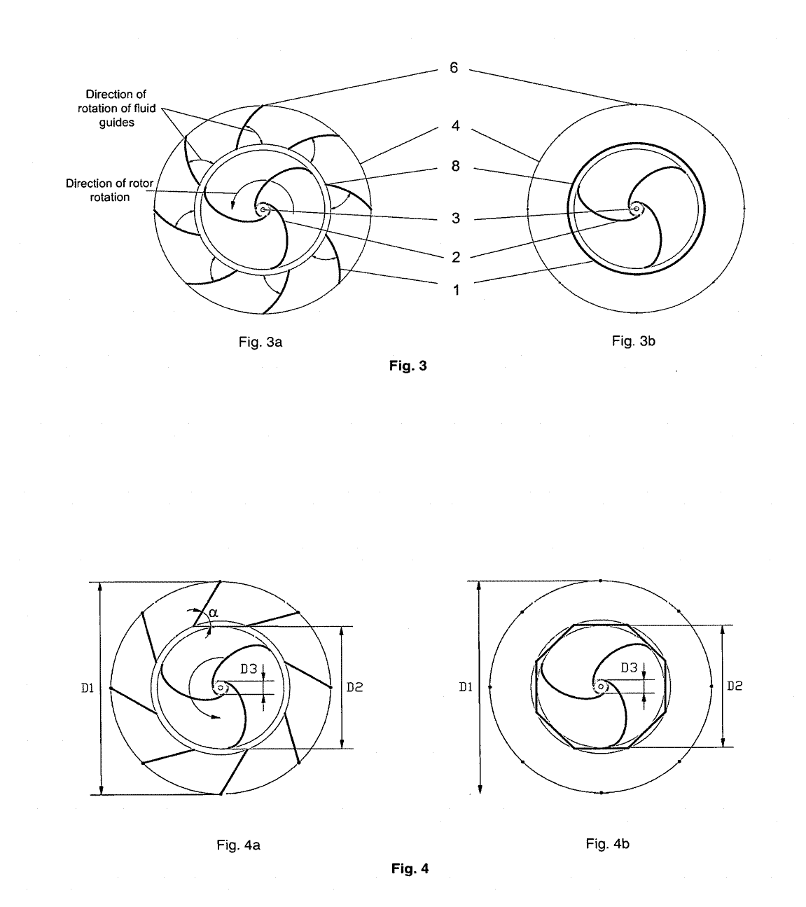

FIG. 3: The FIG. 3 shows a vertical wind turbine/water turbine seen from above in cross-section with the blades, curved fluid guides (wind, water flow . . . ), with rotation direction indication, in operating position (FIG. 3a) and in safety stop position (FIG. 3b).

Where: 1—Fluid guides (wind, water flow . . . ); 2—Rotor blades; 3—Rotor rotation axis; 4—Protective structure; 6—Structuring framework; 8—Fluid guidance rotation axis.

FIG. 4: The FIG. 4 shows a vertical wind turbine/water turbine with trigonometric rotor seen from above in cross-section with the blades, flat fluid guides (wind, water flow . . . ) with the indication of the key parameters, in the operating position (FIG. 4a) and in the safety stop position (FIG. 4b).

Where: D1—Outside diameter of wind turbine/water turbine; D2—Rotor diameter; D3—Diameter of fluid compensation space; α—Angle of orientation of fluid guides.

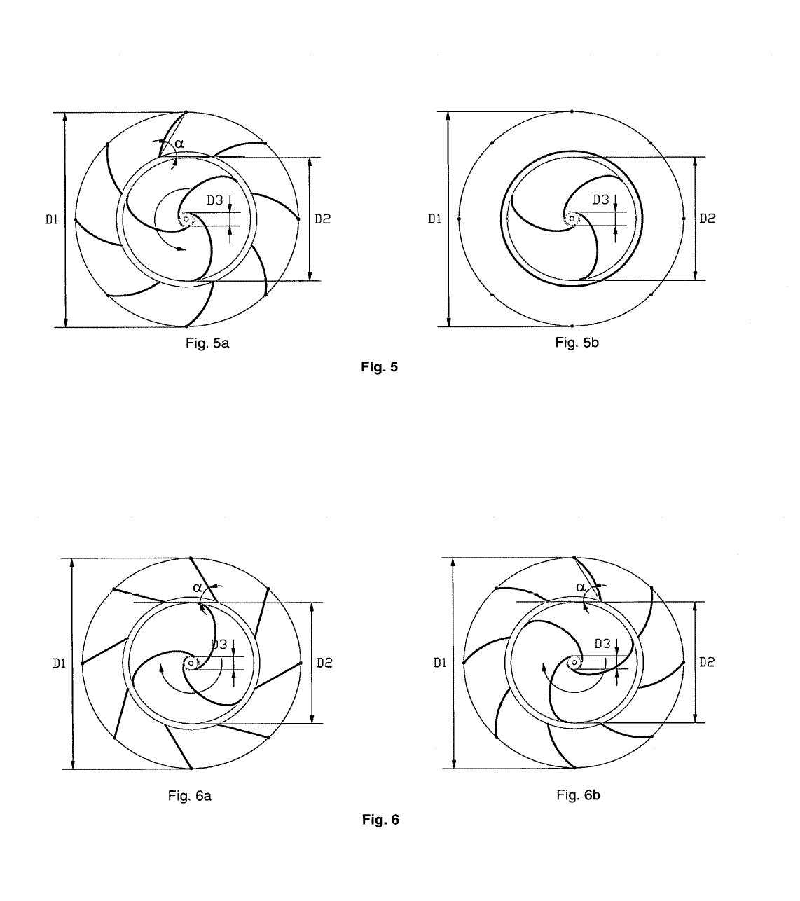

FIG. 5: The FIG. 5 shows a vertical wind turbine/water turbine with trigonometric rotor seen from above in cross-section with the blades, the curved fluid guides (wind, water flow . . . ), with the indication of the key parameters, in the operating position (FIG. 5a) and in the safety stop position (FIG. 5b).

Where: D1—Outside diameter of wind turbine/water turbine; D2—Rotor diameter; D3—Diameter of fluid compensation space; α—Angle of orientation of fluid guides.

FIG. 6: The FIG. 6 shows a vertical wind turbine/water turbine with anti-trigonometric rotor seen from above In cross-section with the blades, the fluid guides (wind, water flow . . . ) flat (FIG. 6a) or curved (FIG. 6b), with the indication of the key parameters in the operating position.

Where: D1—Outside diameter of wind turbine/water turbine; D2—Rotor diameter; D3—Diameter of fluid compensation space; α—Angle of orientation of fluid guides.

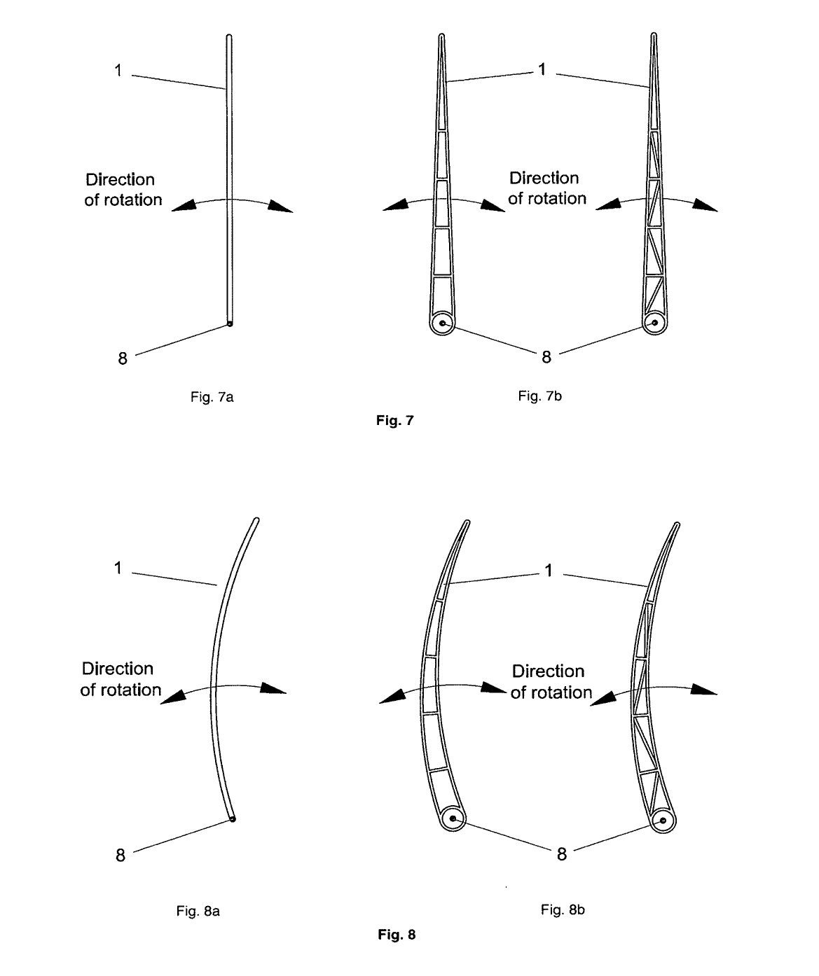

FIG. 7: FIG. 7 shows a cross-sectional view of a flat and regular (FIG. 7a) or reinforced (FIG. 7b) fluid guidance (wind, water flow . . . ).

Where: 1—Fluid guidance (wind, water flow . . . ); 8—Fluid guidance rotation axis.

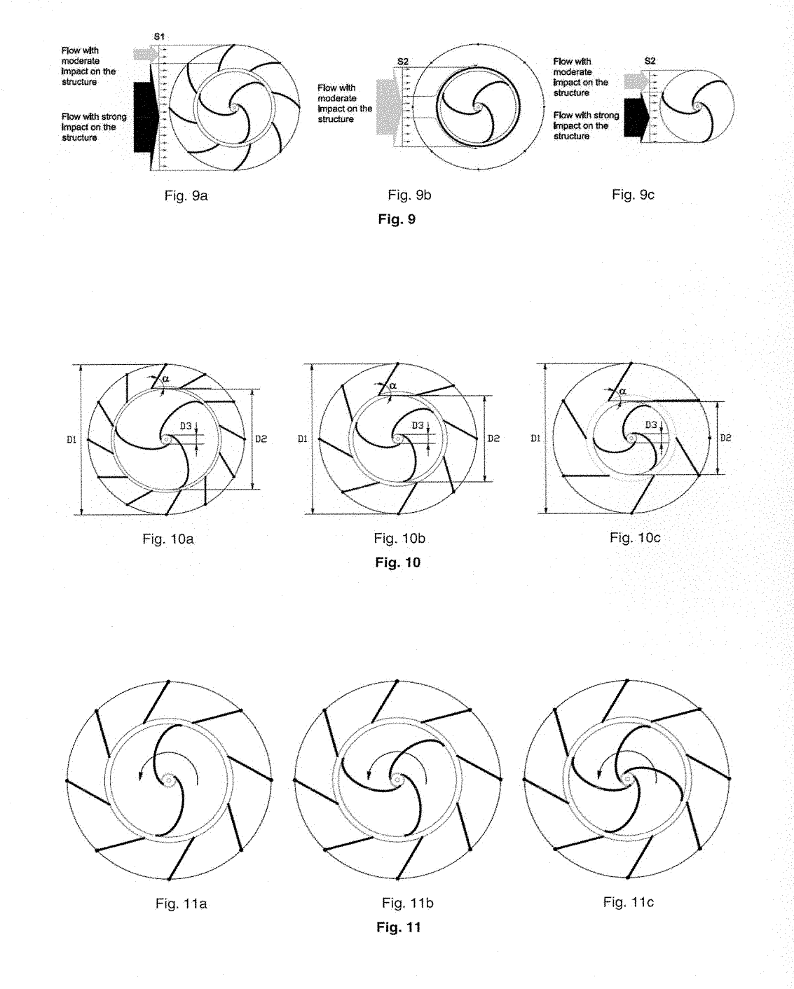

FIG. 8: The FIG. 8 shows a cross-sectional view of a curved and even (FIG. 8a) or reinforced (FIG. 8b) fluid guide (wind, water flow . . . ).

Where: 1—Fluid guide (wind, water flow . . . ); 8—Fluid guidance rotation axis.

FIG. 9: The FIG. 9 shows a simplified illustration of the fluid impact (wind, water flow . . . ) on the structure of the wind turbine/water turbine: FIG. 9a—Fluid guides (wind, water flow . . . ) in operating position; FIG. 9b—Fluid guides (wind, water flow . . . ) in safety stop position; FIG. 9c—Wind turbine/water turbine without fluid guides (wind, water flow . . . ).

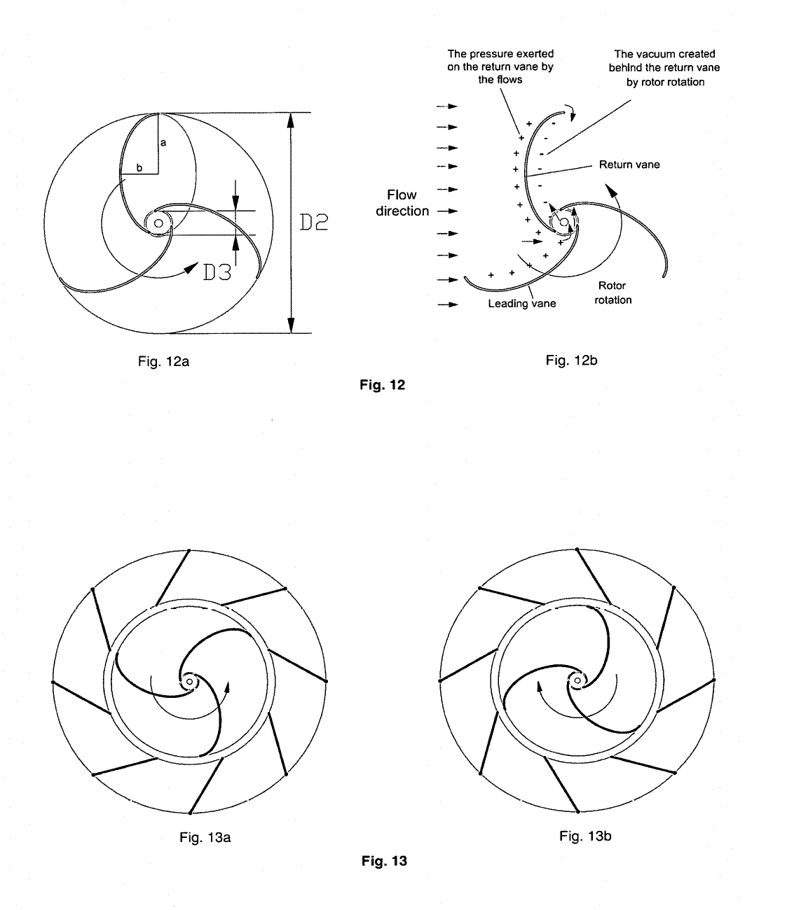

FIG. 10: The FIG. 10 shows a vertical wind turbine/water turbine seen from above in cross-section with flat fluid guides (wind, water flow . . . ) with different D1/D2 ratios: FIG. 10a—Wind turbine/water turbine with 12 fluid guides (wind, water flow . . . ) (D1/D2=1.2-1.6/1); FIG. 10b—Wind turbine/water turbine with 8 fluid guides (wind, water flow . . . ) (D1/D2=1.6-1.9/1); FIG. 10c—Wind turbine/water turbine with 6 fluid guides (wind, water flow . . . ) (D1/D2=1.9-3/1).

Where: D1—Outside diameter of wind turbine/water turbine; D2—Rotor diameter; D3—Diameter of fluid compensation space; α—Angle of orientation of fluid guides.

FIG. 11: The FIG. 11 shows a vertical wind turbine/water turbine seen from above in cross-section equipped with flat fluid guides (wind, water flow . . . ) and trigonometric rotor with variable number of blades: FIG. 11a—Wind turbine/water turbine with 2 blades rotor; FIG. 11b—Wind turbine/water turbine with 3 blades rotor; FIG. 11c—Wind turbine/water turbine with 4 blades rotor.

FIG. 12: The FIG. 12 shows the architecture of a three-blades rotor seen from above in cross-section: FIG. 12a—Three-blades rotor with key parameters; FIG. 12b—Three-blades rotor with illustration of the flow and pressure exerted on the blades.

Where: D2—Rotor diameter; D3—Fluid compensation space diameter; a—Half major axis; b—Half minor axis.

FIG. 13: The FIG. 13 shows a view from above in cross-section of a Wind turbine/water turbine with trigonometric rotor (FIG. 13a) and with anti-trigonometric rotor (FIG. 13b).

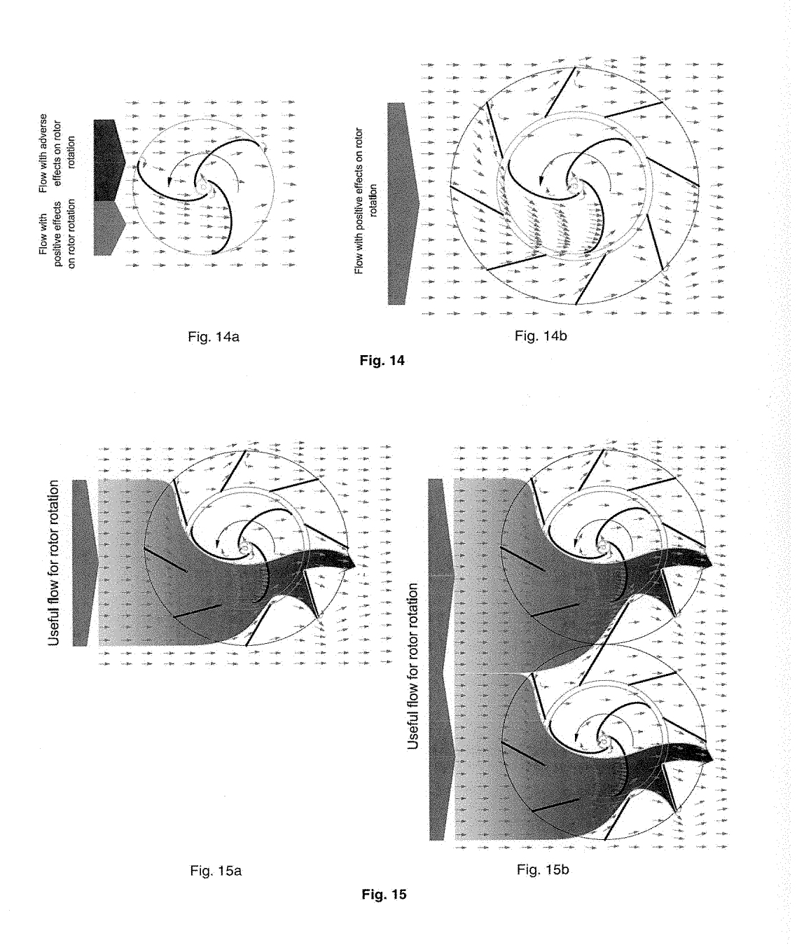

FIG. 14: The FIG. 14 shows a diagram of fluid flow (wind, water flow . . . ) on wind turbines/water turbines without and with fluid guides (wind, water flow . . . ): FIG. 14a—Wind turbine/water turbine without fluid guides (wind, water flow . . . ); FIG. 14b—Wind turbine/water turbine equipped with fluid guides (wind, water flow . . . ).

FIG. 15: The FIG. 15 shows a fluid flow diagram (wind, water flow . . . ) on a standalone wind turbine/water turbine and on an assembly of two wind turbines/water turbines: FIG. 15a—View on a standalone wind turbine/water turbine; FIG. 15b—View on a cluster of two wind turbines/water turbines.

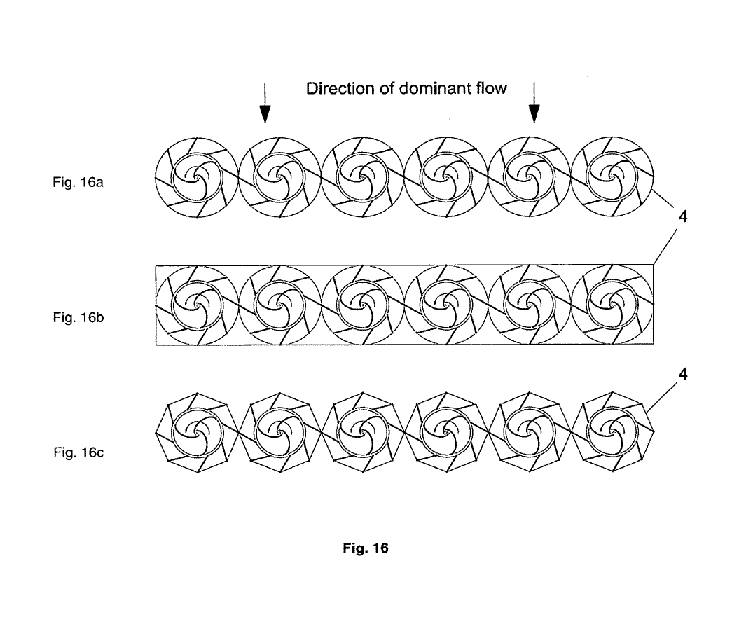

FIG. 16: The FIG. 16 shows a schematic view of a rectilinear assembly of wind turbines/water turbines with different designs of the protective structure. FIG. 16a—Individual protective structure in form of individual cylinders; FIG. 16b—Overall protective structure in form of flat walls; FIG. 16c—Individual protective structure in form of octagonal tubes.

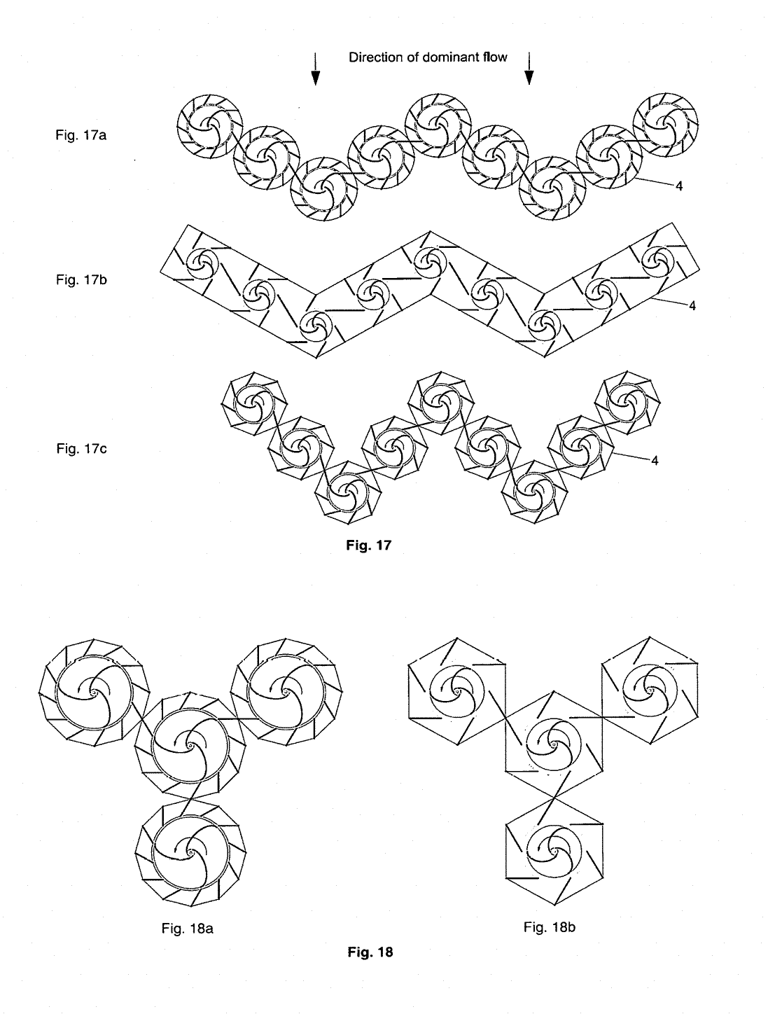

FIG. 17: The FIG. 17 shows a schematic view of a zigzag assembly of wind turbines/water turbines. FIG. 17a—Individual protective structure in form of individual cylinders; FIG. 17b—Overall protective structure in form of flat walls; FIG. 17c—Individual protective structure in form of octagonal tubes.

FIG. 18: The FIG. 18 shows a schematic view of an assembly of wind turbines/water turbines in form of star or Y-shaped. FIG. 18a—Assembly of wind turbines/water turbines with 12 fluid guides; FIG. 18b—Assembly of wind turbines/water turbines with 6 fluid guides.

FIG. 19: The FIG. 19 shows a schematic view of an assembly of wind turbines/water turbines in form of cross-shaped. FIG. 19a—Assembly of wind turbines/water turbines with 12 fluid guides; FIG. 19b—Assembly of wind turbines/water turbines with 8 fluid guides.

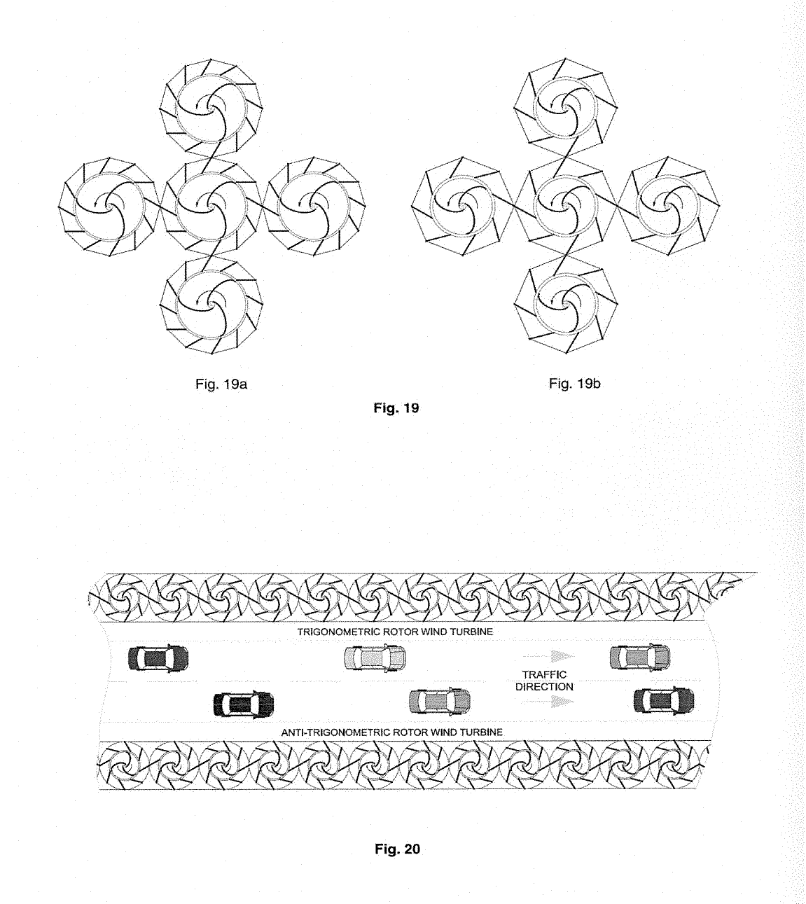

FIG. 20: The FIG. 20 shows a schematic view of an assembly of wind turbines along one-way road and rail transport networks (railways, motorways, roads, etc.).

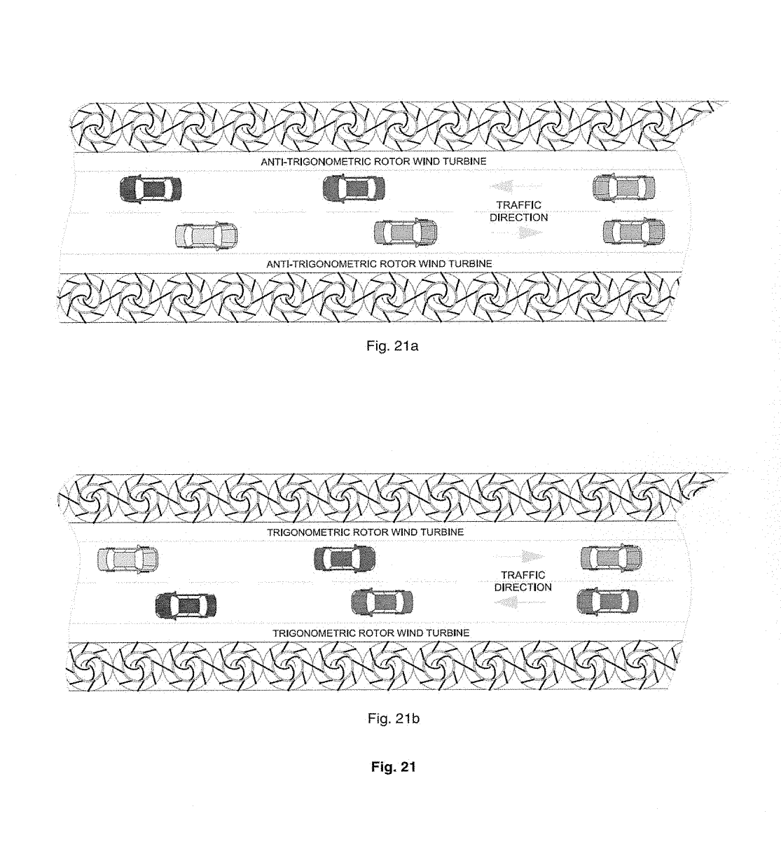

FIG. 21: The FIG. 21 represents a schematic view of an assembly of wind turbines along two-way road and rail transport networks (railways, motorways, roads, etc.) without separation lane or central median: FIG. 21a—Right-hand traffic transport networks; FIG. 21b—Left-hand traffic transport networks.

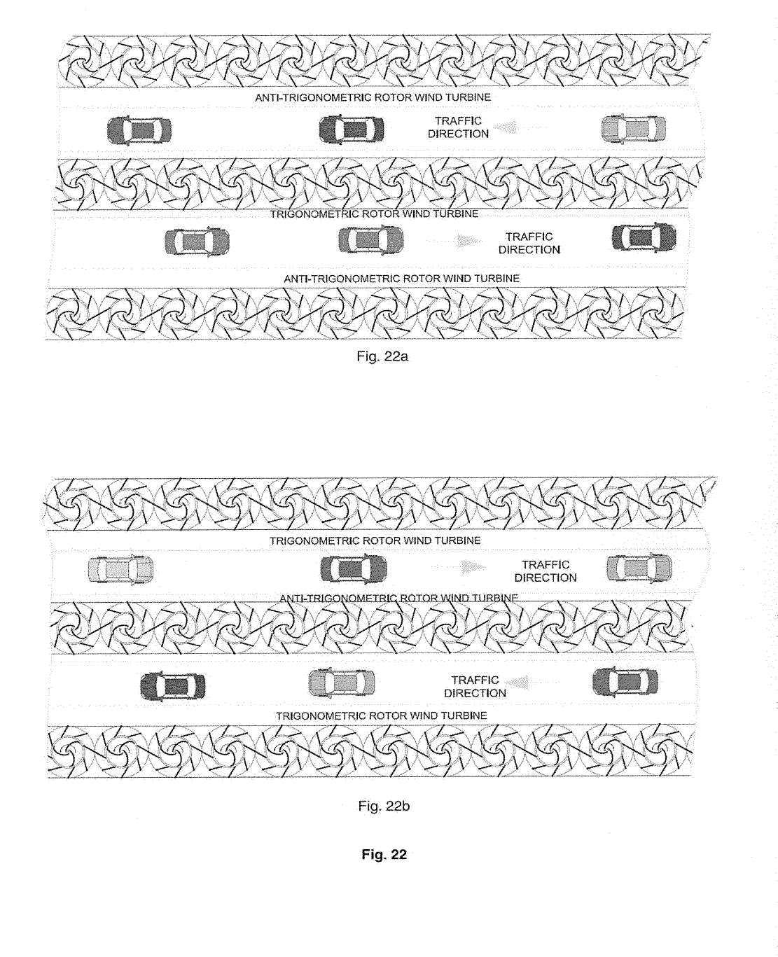

FIG. 22: The FIG. 22 shows a schematic view of an assembly of wind turbines along two-way road and rail transport networks (railways, motorways, roads, etc.) with lane separation or with the central median: FIG. 22a—Right-hand traffic transport networks; FIG. 22b—Left-hand traffic transport networks.

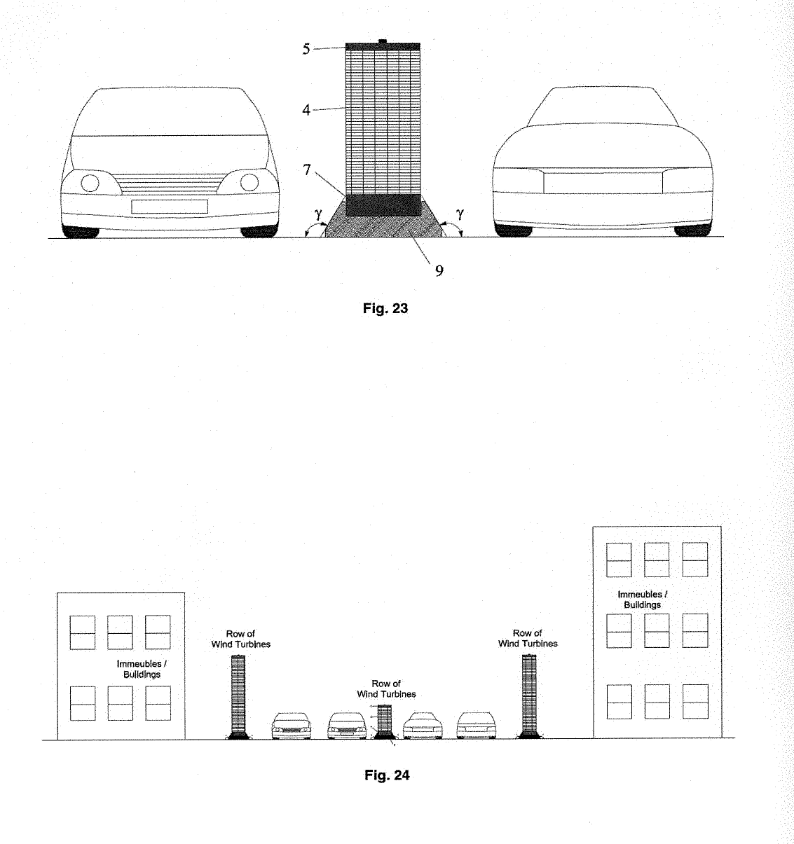

FIG. 23: The FIG. 23 shows an illustration of the cross-sectional side view of a wind turbine structure installed in the lane separation space or on the central median of road and rail transport networks (rail networks, motorways, roads, etc.) (γ>90°). Where: 4—Protective structure; 5—Top box; 7—Bottom box; 9—Wind turbine base; γ—angle between roadway and exterior façade of the wind turbines base.

FIG. 24: The FIG. 24 illustrates the structures of wind turbines installed along and on the central median of road and rail transport networks (roads, motorways, rail networks, etc.) playing the role of noise barriers and safety barriers.

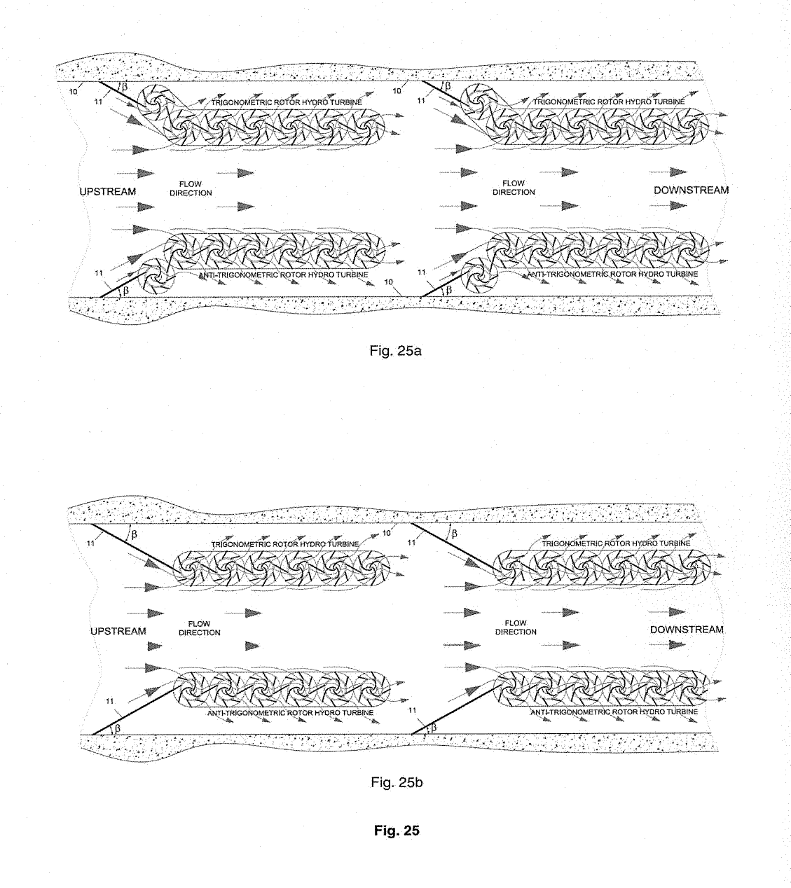

FIG. 25: The FIG. 25 shows a schematic view of an assembly of water turbines immersed in water along rivers, watercourses, etc. FIG. 25a—Configuration with water turbines installed in parallel to the riverside and on the flow reduction line; FIG. 25b—Configuration with water turbines arranged in parallel at the riverside only.

Where: 10—Riverside; 11—Flow reduction wall; 13—Flow reduction angle.

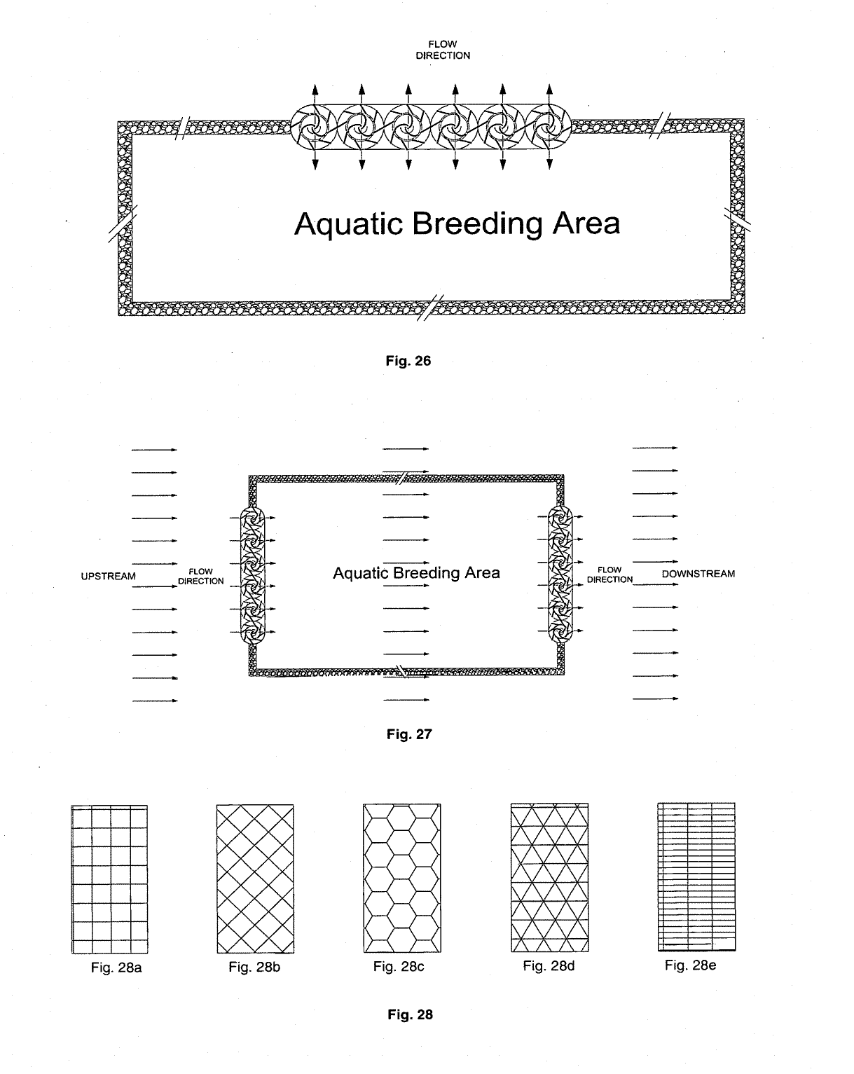

FIG. 26: The FIG. 26 shows a schematic view of an assembly of the water turbines submerged in the water at each opening of the aquatic breeding areas or marine areas.

FIG. 27: The FIG. 27 shows a schematic view of an assembly of water turbines immersed in water at each opening of the aquatic breeding areas installed in the rivers.

FIG. 28: The FIG. 28 represents the architecture of the protective structure: FIG. 28a—Square mesh; FIG. 28b—Diamond mesh; FIG. 28c—Hexagonal mesh; FIG. 28d—Triangular mesh; FIG. 28e—Rectangular mesh.

The FIG. 1 represents a general view of a vertical wind turbine/water turbine of the present invention. The aforesaid wind turbine/water turbine is composed of fluid guides (wind, water flow, etc.) (1) which extend vertically in parallel to the axis of the rotor rotation (3), rotor blades (2), a protective structure (4), a top box (5), a structuring framework (6) and a bottom box (7). The bottom and top boxes can contain a mechanical transmission system, a gearbox, an electric generator, a braking system, an inverter, electrical outputs, a fluid guidance rotation system, a control and regulation system, a safety system, a cooling system, a Maglev technology system, a wireless electric charging system, a set of batteries and a fixing system, etc.

The fluid guidance system (1) can consist of flat walls (FIG. 2, FIG. 4, FIG. 6a, FIG. 7) or curved walls (FIG. 3, FIG. 5, FIG. 6b, FIG. 8). The fluid guidance system can be equipped with a rotation system turning around its own axis (8) (FIG. 2, FIG. 3, FIG. 7 and FIG. 8) and in parallel to the rotor rotation axis (3). The fluid guides can consist of a regular structure (FIG. 7a and FIG. 8a) or of a reinforced structure (FIG. 7b and FIG. 8b). The rotor blade structure is designed in the same way (regular or reinforced structure).

The position of the fluid guides depends on the speed of the rotor and of fluids eventually. In case of aggressive flow or excessive rotor speed, the fluid guides close progressively up to the safety stop position (FIG. 2b, FIG. 3b, FIG. 4b and FIG. 5b). In the safety stop position, the fluid guides form a cylinder, a pseudo-cylinder or a polygonal tube that allows to lighten the impacts of excessive flows on the structure of the wind turbine/water turbine, because the fluid flows will bypass around the flow guides instead of impacting on its large surface (FIG. 9).

The wind turbines/water turbines of this invention are characterized by key parameters illustrated in FIGS. 4, 5 and 6, and presented below:
D1: The outer diameter of the wind turbine/water turbine that envelops the fluid guides and protective structure,
D2: The rotor diameter D2 which envelops the rotor blades,
D3: The diameter of the fluid compensation space,
α: The orientation angle of the fluid guides. This is the absolute angle between the fluid guide in the operating position and the fluid guide in the safety stop position (FIG. 4a, FIG. 5a, FIG. 6a and FIG. 6b).
The height of the wind turbine/water turbine H.

The orientation angle α of the fluid guides of the wind turbines/water turbines of this invention includes absolute values between 0° and 80° (FIG. 4, FIG. 5 and FIG. 6). In the safety stop position, the angle α is at 0°. In operating condition, the optimum angle α value includes absolute values between 50° and 70°, with a value of 60° recommended for the best efficiency by orienting flows having adverse effects on rotor rotation towards the leading blade and by significantly reducing the force of the flows pressed on the return blade (FIG. 14).

The wind/water turbines of the present invention have a D1/D2 ratio which includes values between 1/1 and 4/1. This envelops the typical wind turbines/water turbines with 12, 8 and 6 fluid guides (FIG. 10a, FIG. 10b and FIG. 10c).

Wind turbines/water turbines with high D1/D2 ratio, such as those with 6 fluid guides are intended for locations where flows are at low velocity, while wind turbines/water turbines with low D1/D2 ratio such as those with 12 fluid guides are more suitable for locations where flows (wind or water currents) are high velocity.

The height H of wind turbine/water turbine is variable depending on the application and the location of the installations.

The rotor of the wind turbines/water turbines of this invention is composed of at least two blades arranged regularly and placed inside the fluid guidance system (FIG. 11).

The blades of this invention are designed in an elliptical shape (FIG. 12). They can be in the form of curved wings of ordinary type which extend in parallel with the rotation axis (3) of the rotor, or of helical type which are helically twisted around the rotation axis (3). The shape of the blades is optimized and dimensioned by the ratio a/b (FIG. 12a) which is in a range between 1 and 10.

The fluid compensation space D3 (FIG. 4, FIG. 5, FIG. 6, FIG. 10 and FIG. 12) allows a part of fluid to pass from the leading blade to the rear of the return blade. This allows to compensate the vacuum behind the return blade created by blade movements (FIG. 12b), thus improving the efficiency or effectiveness of the wind turbine/water turbine. The figure FIG. 12b clearly shows the reason of the low efficiency of wind turbines/water turbines without fluid guides.

The rotor of this invention has a D3/D2 ratio which includes values between 1/2 and 1/20.

The direction of rotation of the rotor of the aforesaid device (wind turbine/water turbine of the present invention) is constant trigonometric or anti-trigonometric whatever the direction of the flows. The direction of the rotor rotation depends on the architecture of the blades and the fluid guides. Two types of aforesaid device are proposed: the device (wind turbine/water turbine) with trigonometric rotor (FIG. 13a) and the device (wind turbine/water turbine) with anti-trigonometric rotor (FIG. 13b). These types of aforesaid device may create different efficiencies in specific locations where the velocity of fluids varies in space. Therefore, the choice of the type of aforesaid device will come from a specific preliminary study on site for each location.

The design of the fluid guides of this invention (FIG. 14) makes it possible to convert flows having negative effects on the rotor rotation into useful flows or flows having positive effects on the rotor rotation, by directing them towards the leading blade and significantly reducing the force of the flows pressed on the return blade (FIG. 12).

The architecture of the fluid guides, the rotor blades and the modes of assembly of the aforesaid devices (wind turbines/water turbines of the present invention) are essential for their efficiency. The FIG. 15 clearly shows the advantage of combining the two devices compared to an standalone or isolated device.

In the operating position, if the adjacent guides of two aforesaid joined devices form a continuous wall, almost all of the flows can become beneficial for rotor rotation, because the fluid guides of two aforesaid adjacent devices jointly direct and promote the flow of all fluids to the leading blades. Therefore, the assembly of wind turbines/water turbines of the present invention according to the specific gathering modes will significantly improve the efficiency of vertical wind turbines/water turbines.

By linking aforesaid devices on a straight line perpendicular to the direction of the dominant flows, aforesaid devices will create a wall facing the flows and will recover almost all of the flows to rotate the rotor (FIG. 16). The zigzag (FIG. 17), Y-shaped (FIG. 18) and star-shaped (FIG. 19) assembly modes of these devices are also very beneficial for locations where the direction of flow is variable. These architectures also allow to reinforce the overall stability of the structure of the set of these devices.

Along the road and rail transport networks (roads, rail networks, etc.), the wind turbines of the present invention are assembled in straight or curved rows parallel to the transport network. These devices will also act as contactless electric charging systems along transport networks.

Our research results confirmed that the direction of flow and type of the aforesaid devices (trigonometric rotor or anti-trigonometric rotor) have an important influence on the productivity of the wind turbines of the present invention. In order to obtain the best performance for the wind turbines of the present invention:
Along one-way traffic road and rail transport networks (roads, rail networks, etc.), wind turbines with anti-trigonometric rotor should be installed on the right side, while trigonometric rotor wind turbines should be installed on the left side as shown in FIG. 20.
Along two-way traffic road and rail transport networks (roads, rail networks, etc.), anti-trigonometric rotor wind turbines must be installed on two sides of the right-hand traffic transport networks (FIG. 21a, FIG. 22a), while trigonometric rotor wind turbines must be installed on two sides of the left-hand traffic transport networks (FIG. 21b, FIG. 22b).
Trigonometric rotor wind turbines must be installed on the central median of road and rail transport networks (roads, rail networks, etc.) with right-hand traffic (FIG. 22a), while anti-trigonometric rotor wind turbines must be installed on the central median of road and rail transport networks (roads, rail networks, etc.) with left-hand traffic (FIG. 22b).

The architecture of the base of the wind turbines/water turbines of the present invention also has an influence on their performance. The angle γ between the roadway or river bottom and the surface or exterior façade of the wind turbine base should be greater than 90° (FIG. 23) to obtain a better performance.

The architecture of the wind turbines of the present invention allows to adsorb/block light and sound s waves. Thus, the rows of these aforesaid devices will also play the role of noise barriers and safety barriers along and in the middle on the central median of road and rail transport networks (roads, rail networks, etc.) (FIG. 23, FIG. 24), on balconies, on building terraces, etc.

In watercourses, rivers or streams, the water turbines of this invention will be immersed in water, assembled and installed in parallel to the riverside and on the flow reduction line (FIG. 25). Aforesaid water turbines will also play the role of wireless electric charging systems along fluvial transport networks (rivers, streams, etc.). These groups of aforesaid water turbines will be spaced periodically to regenerate the velocity of the watercourse. A flow reduction wall will be placed upstream of each group of aforesaid water turbines and inclined with respect to the riverside an angle β (current reduction angle) which will take the value between 10° and 80° according to the location.

In order to obtain the best efficiency, aforesaid water turbines with anti-trigonometric rotor must be installed on the right bank side, while aforesaid water turbines with trigonometric rotor must be installed on the left bank side. These installations will allow to avoid the construction of hydraulic dams in rivers.

The water turbines of the present invention may be installed in coastal areas, at the entrance of the draining and filling zones of the basins or at each opening of the aquatic breeding zones. The aforesaid water turbines can be assembled in rows at each opening of the aquatic farming areas (FIG. 26, FIG. 27) and of the emptying and filling areas of the basins. In large coastal areas where the direction of the sea currents and waves is variable, the water turbines will be assembled in zigzag shape to better capture the energy of the sea currents and waves.

Numerous designs of the protective structure (4) of the wind turbines/water turbines of the present invention are proposed and illustrated in FIG. 1, FIG. 16, FIG. 17 and FIG. 28. The protective structure can be in the form of square mesh (FIG. 28a), diamond mesh (FIG. 28b), hexagonal mesh (FIG. 28c), triangular mesh (FIG. 28d), rectangular mesh (FIG. 28e). In rows of these devices, the protective structure can be in the form of individual cylinders (FIG. 16a, FIG. 17a), flat walls (FIG. 16b, FIG. 17b) and polygonal tubes (FIG. 16c, FIG. 17c). This improves their aesthetics and safety for children, birds, animals, fishes, etc. So, their environmental impacts will be very reduced. The aforesaid protective structure (4) can be made of different materials, such as natural materials, synthetic materials, metals, alloys, plastics, fibers or fabrics, etc.

The device of this invention is intended for companies or organizations producing electricity and individuals wishing to produce electricity on a small scale on a large scale. The present invention being part of sustainable technologies offers a small contribution for the development of renewable energy sources, for the period of post fossil energy era.

I claim as illustrated in the figures and described in the description:

1) Device converting into mechanical and electrical energy, the energy generated by the different types of flows (air flow, wind, watercourses, rivers, marine or fluvial currents, waves and tides), characterized in that it is composed of:
a fluid guidance system (1) allowing to collect more flows, directing the flows having negative effects on the rotation of the rotor into flows having positive effects on the rotor rotation, extending the operating conditions of aforesaid device to a lower and higher speed or velocity of the flows, thus increasing the effective operating period of aforesaid device;
the rotor being made up of blades/vanes (2) arranged regularly and located inside the fluid guiding system (1);
a protective structure (4) being arranged outside the fluid guidance system (1) (FIG. 1-3) to ensure safety with respect to children, birds, animals and fishes;
a structuring framework (6) being arranged around and at the border of aforesaid device (FIG. 1-3);
a top box (5) and a bottom box (7) being arranged above and below the fluid guides and the rotor (FIG. 1). Aforesaid bottom and top boxes contain a mechanical transmission system, a gearbox, an electrical generator, a braking system, an inverter, electrical outputs, a fluid guides rotation system, a control and regulation system, a safety system, a cooling system, a system of Maglev technology, a wireless electric charging system, a set of batteries and a fixing system of aforesaid device.
Aforesaid device is called a “wind turbine” or “wind turbine version” if it transforms wind energy generated by air flows or wind, and is called a “water turbine” or “water turbine version” if it transforms hydraulic energy from watercourses, rivers, marine or fluvial currents, waves and tides.

2) Device according to claim 1, characterized in that the fluid guiding system (1) is arranged regularly around the rotor (FIGS. 1-3). In the safety stop position, the fluid guides envelop completely the rotor (FIGS. 2b, 3b, 4b and 5b). The fluid guides consist of flat walls (FIG. 2, FIG. 4, FIG. 6a, FIG. 7) or curved walls (FIG. 3, FIG. 5, FIG. 6b, FIG. 8). Each fluid guide (1) is equipped with a rotation system that turns on its own axis (8) (FIG. 2, FIG. 3, FIG. 7 and FIG. 8) in parallel to the rotor rotation axis (3). The fluid guides (1) make of a regular structure (FIG. 7a and FIG. 8a) or a reinforced structure (FIG. 7b and FIG. 8b). The position of the fluid guides (1) depends on the speed of the rotor and of the fluids eventually. In case of aggressive flow or excessive rotor speed, the fluid guides gradually close up to the safety stop position (FIG. 2b, FIG. 3b, FIG. 4b and FIG. 5b) in the form of a cylinder, a pseudo-cylinder or a polygonal tube which allows to lighten the impacts of excessive flow on the structure of the said device (FIG. 9). The orientation angle α of the fluid guides (1) takes absolute values between 0° and 80° (FIG. 4, FIG. 5 and FIG. 6): in safety stop position the angle α is at 0°, in operating condition the optimum value of the angle α takes absolute values between 50° and 70°, with a value of 60° recommended for the best efficiency by orienting flows having harmful effects on the rotor rotation towards the leading vane and by significantly decreasing the force of the pressed flows on the return vane (FIG. 14). The ratio D1/D2 takes values between 1/1 and 4/1, this envelops aforesaid typical devices (wind turbines/water turbines) with 12, 8 and 6 fluid guides (FIG. 10a, FIG. 10b and FIG. 10c). The aforesaid devices with high D1/D2 ratio such as the 6 fluid guides wind turbines/water turbines (FIG. 10c) are intended for locations where flows are at low velocity, while the aforesaid devices with low D1/D2 ratio such as wind turbines/water turbines with 12 fluid guides (FIG. 10a) are more suitable for locations where flows (wind or water currents) are at high velocity.

3) Device according to the above claims, characterized in that the rotor consists of blades/vanes arranged in a regular manner and placed inside the fluid guiding system (FIG. 11). The aforesaid blades composed of a regular structure (FIG. 8a) or reinforced structure (FIG. 8b) are designed in an elliptical shape (FIG. 12) of ordinary type which extend parallel to the rotation axis (3) of the rotor, or of helical type which are twisted helically about the axis of rotation (3). The shape of the blades is characterized by the ratio a/b (FIG. 12a) which is in a range between 1 and 10. The fluid compensation space D3 (FIG. 4, FIG. 5, FIG. 6, FIG. 10 and FIG. 12) allows a part of fluid to pass from the leading vane to the rear of the return vane in order to compensate the vacuum behind the return vane created by movements of blades (FIG. 12b), thus improving the efficiency or effectiveness of aforesaid device. The optimum D3/D2 ratio takes values between 1/2 and 1/20.

4) Device according to the preceding claims, characterized in that the direction of the rotor rotation of aforesaid device is constant trigonometric or anti-trigonometric whatever the direction of the flows. The direction of rotor rotation depends on the architecture of the blades and the fluid guides. Two types of this device are proposed: the device with trigonometric rotor (FIG. 13a) and the device with anti-trigonometric rotor (FIG. 13b).

5) Device according to the above requirements, characterized in that in the operating position, the adjacent fluid guides of the assembled devices form a continuous wall (FIG. 15b, FIG. 16, FIG. 17, FIG. 18, FIG. 19, FIG. 20, FIG. 21, FIG. 22, FIG. 25, FIG. 26 and FIG. 27) to direct and foster jointly the flow of all fluids to the leading vanes. These devices will be assembled in form of a straight line (FIG. 16), zigzag (FIG. 17), Y shape (FIG. 18) or star shape (FIG. 19) to enhance their overall stability and effectiveness in different environments.

6) Use of the device according to the preceding claims, characterized in that, along road and rail transport networks, the aforesaid devices are assembled in straight or curved rows in parallel to the transport network. Aforesaid devices will also act as contactless electric charging systems along transport networks. Along one-way traffic transport networks, aforesaid devices with anti-trigonometric rotor shall be installed on the right side, while aforesaid trigonometric rotor devices shall be installed on the left side (FIG. 20). Along two-way traffic transport networks, aforesaid anti-trigonometric rotor devices shall be installed on two sides of the right-hand traffic transport networks (FIG. 21a, FIG. 22a), while aforesaid trigonometric rotor devices shall be installed on two sides of the left-hand traffic transport networks (FIG. 21b, FIG. 22b). The aforesaid trigonometric rotor devices shall be installed on the central median of the right-hand traffic transport networks (FIG. 22a), while the aforesaid anti-trigonometric rotor devices shall be installed on the central median of the left-hand traffic transport networks (FIG. 22b). The angle γ between the road surface or river bottom and the façade or outer surface of the base of aforesaid device should be greater than 90° (FIG. 23) to obtain better performance.

7) Use of the device according to the previous claims characterized in that the wind turbine version of the aforesaid device is designed and optimized to adapt to any environment where the wind can be present, onshore and offshore such as along highways, roads, rail networks, in tunnels, on fields, on hills, on buildings, on roofs, on balconies, on terraces or along riversides, along seaside, in offshore wind farms. The rows of aforesaid devices will also play the role of noise barriers and safety barriers with an ability to destroy lights and sound waves along the roadside and in the middle on the central median of road and rail transport networks (FIGS. 20-24), on terraces, on balconies and on buildings.

8) Use of the device according to claims 1 to 5, characterized in that in watercourses, in rivers or in streams, aforesaid devices will be immersed in water, assembled and installed in parallel to the riverside and on the flow reduction line (FIG. 25). Aforesaid devices rows installed along the rivers will also act as anti-wave walls protecting the dykes against erosions caused by water flows and waves, and as contactless electric charging systems along the waterway transport networks. Sets of aforesaid devices will be spaced periodically (FIG. 25) to regenerate the velocity of the water stream. A flows reduction wall will be placed upstream of each group of aforesaid devices and inclined with respect to the riverside by an angle β (flow reduction angle) which will take the value between 10° and 80° depending on the location. The aforesaid devices with anti-trigonometric rotor shall be installed on the right riverside, while the aforesaid trigonometric rotor devices shall be installed on the left bank side (FIG. 25).

9) Use of the device according to claims 1 to 5 and 8, characterized in that aforesaid devices will be installed in the coastal zones, at the entrance of the draining and filling zones of the basins or at each opening of the aquatic breeding zones. The aforesaid devices shall be assembled in a straight row (FIG. 16) at each opening of the aquatic breeding zones (FIG. 26, FIG. 27) and the draining and filling zones of basins. In large coastal areas where the direction of marine currents and waves is variable, aforesaid devices will be in form of zigzag (FIG. 17) to better capture the energy of marine currents and waves. The rows of aforesaid devices installed along the coastal areas will also act as anti-wave walls protecting dykes against erosions caused by water currents and waves.

10) Device according to claims 1 to 5 characterized in that the protective structure (4) or protective grid enveloping aforesaid device (FIGS. 1-3, FIG. 16, FIG. 17, FIG. 23, FIG. 28) depends on its use, and is in the form of square mesh (FIG. 28a), diamond mesh (FIG. 28b), hexagonal mesh (FIG. 28c), triangular mesh (FIG. 28d) and rectangular mesh (FIG. 23, FIG. 24, FIG. 28e). Assembled in row aforesaid devices, the protective structure will be in the form of individual cylinders (FIG. 16a, FIG. 17a), flat walls (FIG. 16b, FIG. 17b) and polygonal tubes (FIG. 16c, FIG. 17c). Aforesaid protective structure (4) ensures the safety of children, birds, animals and fish while allowing fluid flows go through (FIG. 14, FIG. 15, FIG. 25, FIG. 26 and FIG. 27). Aforesaid protective structure (4) will be made of different materials, such as natural materials, synthetic materials, metals, alloys, plastics, fibers or fabrics.
